(19) United States
(12) Patent Application Publication
(10) Pub. No.: US 2024/0176206 A1
(43) Pub. Date: May 30, 2024

(54) INTERFACE-BASED THIN FILM METROLOGY USING SECOND HARMONIC GENERATION

(71) Applicant: KLA Corporation, Milpitas, CA (US)

(72) Inventors: Qiang Zhao, Milpitas, CA (US); Ming Di, Hayward, CA (US); Xi Chen, Milpitas, CA (US); Shova Subedi, Milpitas, CA (US); Tianhao Zhang, Milpitas, CA (US)

(21) Appl. No.: 18/116,187

(22) Filed: Mar. 1, 2023

Related U.S. Application Data
(60) Provisional application No. 63/428,446, filed on Nov. 29, 2022.

(51) Int. Cl. G02F 1/35; G01N 21/63; G01N 21/95

(52) U.S. Cl. CPC G02F 1/3532; G01N 21/636; G01N 21/9501; G01N 2021/0125

(57) ABSTRACT

A metrology system may include an illumination source to generate an illumination beam and an illumination sub-system to direct the illumination beam to a sample with an inversion-symmetric substrate and one or more films disposed on the inversion-symmetric substrate. The system may further include a filter configured to block a wavelength of the illumination beam and pass a wavelength associated with a second harmonic of the illumination beam and a detector to capture second harmonic generation (SHG) light. The system may further include a controller to receive metrology data from the detector associated with the SHG light from with an interface between the inversion-symmetric substrate and the one or more films and generate one or more metrology measurements associated with the one or more films based on the metrology data.

### CROSS-REFERENCE TO RELATED APPLICATION

The present application claims the benefit under 35 U.S.C. § 119(e) of U.S. Provisional Application Ser. No. 63/428,446, filed Nov. 29, 2022, naming Qiang Zhao, Ming Di, Xi Chen, Shova Subedi, and Tianhao Zhang as inventors, which is incorporated herein by reference in the entirety.

### TECHNICAL FIELD

The present disclosure relates generally to thin film metrology and, more particularly, to surface-selective thin film metrology using second harmonic generation.

### BACKGROUND

In the fabrication of advanced semiconductor MOSFET (metal on silicon field effect device) device, high-k dielectric metal gate (HKMG) has been widely used in order to pursue better performance, lower power, smaller area and lower cost (PPAC). For example, interfacial SiO₂ and high-k dielectrics such as HfO₂ are commonly used as gate materials in MOSFET devices. In order to modify the device threshold voltage without increasing the gate dielectric gate thickness significantly, the widely adopted approach is to introduce or dope another oxygen-rich or oxygen-deficient metal oxide, also called interfacial dipole engineering (IDE) layer, into the high-k film. Tight control of the doped content is very critical to achieve device performance and higher yield. Since the IDE equivalent thickness is very small, it is difficult to measure the exact amount into the high-k film as well as the efficiency of this IDE contents in gate dielectric film stack using existing technologies. Similar needs also exist for additional devices such as, but not limited to, ferroelectric FET (field electric device) devices, ferroelectric memory devices, and 2-dimension (2D) FET devices.

### SUMMARY

A metrology system is disclosed in accordance with one or more illustrative embodiments. In one illustrative embodiment, the system includes an illumination source to generate an illumination beam. In another illustrative embodiment, the system includes an illumination sub-system including one or more optical elements configured to direct the illumination beam to a sample, where the sample includes an inversion-symmetric substrate and one or more films disposed on the inversion-symmetric substrate. In another illustrative embodiment, the system includes a filter configured to block a wavelength of the illumination beam and pass a wavelength associated with a second harmonic of the illumination beam. In another illustrative embodiment, the system includes a detector to capture second harmonic generation (SHG) light associated with the second harmonic of the illumination beam. In another illustrative embodiment, the system includes a controller to receive metrology data from the detector associated with the SHG light from with an interface between the inversion-symmetric substrate and the one or more films and generate one or more metrology measurements associated with the one or more films based on the metrology data.

A metrology system is disclosed in accordance with one or more illustrative embodiments. In one illustrative embodiment, the system includes a controller to receive metrology data from a detector associated with second harmonic generation (SHG) light from a sample in response to an illumination beam, where the sample includes an inversion-symmetric substrate and one or more films disposed on the inversion-symmetric substrate. In another illustrative embodiment, the controller generates one or more metrology measurements associated with the one or more films based on the SHG light associated with an interface between the inversion-symmetric substrate and the one or more films.

A method is disclosed in accordance with one or more illustrative embodiments. In one illustrative embodiment, the method includes directing an illumination beam at a sample, where the sample includes an inversion-symmetric substrate and one or more films disposed on the inversion-symmetric substrate. In another illustrative embodiment, the method includes capturing metrology data based on second harmonic generation (SHG) light from the sample associated with an interface between the inversion-symmetric substrate and the one or more films. In another illustrative embodiment, the method includes generating one or more metrology measurements associated with the one or more films based on the metrology data.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A is a block diagram of a second harmonic generation (SHG) metrology system, in accordance with one or more embodiments of the present disclosure.

FIG. 1B is a simplified schematic of a SHG metrology system, in accordance with one or more embodiments of the present disclosure.

FIG. 2 is a side view of a schematic of a sample suitable for interface SHG metrology, in accordance with one or more embodiments of the present disclosure.

FIG. 3A is a side view schematic of an inversion-symmetric substrate formed from silicon with a first film formed as an interfacial layer (IL) of SiO₂ and a second film formed as a high-k material, in accordance with one or more embodiments of the present disclosure.

FIG. 3B is a side view schematic of the materials in FIG. 3A after an interfacial dipole engineering (IDE) process, in accordance with one or more embodiments of the present disclosure.

FIG. 4 is a schematic side view of a gate region of a multi-channel field-effect transistor (FET), in accordance with one or more embodiments of the present disclosure.

FIG. 5A is a simulated plot of the intensity of SHG light as a function of time for different variations of a sample, in accordance with one or more embodiments of the present disclosure.

FIG. 5B is a simulated plot of the intensity of SHG light as a function of time as a result of intermittent exposure of the sample to SHG conditions, in accordance with one or more embodiments of the present disclosure.

FIG. 6 is a plot of the optical extinction coefficient (k) as a function of wavelength for silicon, in accordance with one or more embodiments of the present disclosure.

FIG. 7 is a schematic side view of a gate region of the multi-channel FET of FIG. 4 further depicting wavelength-dependent interface SHG measurements, in accordance with one or more embodiments of the present disclosure.

FIG. 8 is a simplified simulation of the intensity trend of interface SHG in the FET as a function of wavelength, in accordance with one or more embodiments of the present disclosure.

FIG. 9 is a flow diagram illustrating steps performed in a method for interface SHG metrology, in accordance with one or more embodiments of the present disclosure.

FIG. 10 is a flow diagram for a method depicting the generation of a metrology recipe that meets application-specific requirements, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods for surface-selective metrology of thin films based on second harmonic generation (SHG) techniques. In particular, embodiments of the present disclosure are directed to interface SHG measurements for surface-selective metrology of thin film stacks including a substrate with inversion symmetry that precludes SHG in bulk form such as, but not limited to, silicon. For the purposes of the present disclosure, the term inversion-symmetric material is used to describe a material having inversion symmetry such that SHG is zero or weak within the bulk of the material. Put another way, the value of the second-order nonlinear susceptibility (χ⁽²⁾) is zero or sufficiently small so that SHG within the bulk of the material is negligible for a particular application (e.g., the intensity of SHG in the bulk of the material induced by an illumination beam with a selected intensity is negligible).

SHG is a non-linear optical process in which two photons with the same frequency/wavelength interact with an optically non-linear material, combine their energy, and generate a new photon with twice the energy and half the wavelength of the initial photons. Efficient SHG generation typically requires a material that lacks inversion symmetry to provide the requisite conditions for the non-linear optical process. Put another way, SHG depends on the second-order nonlinear susceptibility of a material, which is typically low or zero for centrosymmetric or isotropic materials such that SHG is precluded or at least weak. However, it is contemplated herein that SHG may be generated at the interface of a material with inversion symmetry due to a localized breaking of this inversion symmetry at the interface. For example, the interface region of such a material may include electric dipoles that may give rise to SHG.

As one illustration, the crystalline structure of silicon is diamond-cubic lattice which has inversion symmetry (e.g., is centrosymmetric), so the electric field and polarization vectors in Si bulk are invariant with the inversion system and thus preclude SHG. However, SHG can be generated from the higher-order nonlinear response from the inversion symmetric material by an electric dipole on Si surface and electrical quadrupole response from Si bulk with an external electrical field applied. In particular, inversion symmetry is broken along the normal direction at the surface of silicon such that the second-order surface susceptibility at the interface is non-zero.

It is further contemplated herein that the strength of SHG generation at the interface of such an inversion-symmetric material is highly sensitive to the presence of additional dipoles near the interface. As used herein, the terms intensity and amplitude as related to SHG generation are used interchangeably to refer to the strength or amount of the SHG light. Some embodiments of the present disclosure are directed to systems and methods utilizing interface SHG to characterize the properties of one or more thin films adjacent to an inversion-symmetric substrate. Such measurements may thus provide an indirect measurement of such thin films based on their proximity to an inversion-symmetric substrate.

It is further contemplated herein that such SHG measurements may be well suited for, but not limited to, surface-selective metrology of various field effect transistor (FET) devices such as, but not limited to, a field effect transistor (FET), a metal-oxide-semiconductor FET (MOSFET), a planar FET, a FinFET, gate-all-around (GAA) nanosheet FET, a fork-sheet FET, a complimentary GAA FET, a ferroelectric FET, or a 2D FET.

For example, gate regions of such FET devices typically include a thin film stack including a silicon substrate (e.g., a centrosymmetric material), an interfacial layer (IL) of silicon dioxide (SiO₂), and a high-k dielectric material such as, but not limited to, hafnium dioxide (HfO₂), zirconium dioxide (ZrO₂), HfSiₓO_{y}, or HfOₓN_{y}. As an illustration, current dielectric gate structures of advanced semiconductor devices include a silicon substrate, an IL SiO₂ layer with a thickness of around 5-8 angstroms, and a high-k layer with a thickness of around 10-30 angstroms. Precise control over the voltage characteristics (e.g., a Vₜ value) of the FET device is typically achieved through an interfacial dipole engineering (IDE) layer on the high-k material, which introduces or dopes the high-k dielectric material with oxygen-rich or oxygen-deficient metal oxides to generate dipoles for voltage control. The effective thickness of this IDE layer is typically very small (e.g., on the order of 2 angstroms or thinner) and is thus difficult to monitor for process control, yet critically impacts the performance of the FET.

For example, typical thickness or material analysis techniques such as spectroscopic ellipsometry, x-ray reflectometry (XRR), x-ray fluorescence (XRF), x-ray diffraction (XRD), MetaPULSE, x-ray photoelectron spectrometry (XPS), or transmission electron microscopy (TEM) either provide inadequate resolution, are unable to target the critical gate/channel regions that impact device performance, and/or are unsuitable for characterizing 3D structures. Further, for three-dimensional FET device structures, real or proxy, current techniques are not able to measure IDE doped high-k thin film and ferroelectric thin films and 2D layered thin films on a selected area, such as the channel/gate area of the transistor, without including the same materials at the other locations of the transistor. For example, current techniques may perform suitable thickness and material composition/dose measurements but lack sensitivity to specific surface and interface areas and can thus only provide limited value in terms of measurements that relate directly to device performance. As another example, surface-based techniques, such as scanning probe microscopy, are limited to surface measurements, typically have low measurement throughput, and/or are not suitable for measurements of 3D structures.

In some embodiments, interface SHG light from the interface of the inversion-symmetric substrate (e.g., silicon) is used to characterize the properties of the adjacent IL/high-k/IDE materials such as, but not limited to, layer thickness, layer composition, the presence of defects, charge/trap states, stress/strain, charge mobility, or surface/interface roughness.

Additionally, the high-k/IDE layers are commonly fabricated on various parts of a FET device, but device performance (e.g., the Vₜ value) is determined primarily by the properties of the high-k/IDE layers at the gate/channel interface, where the high-k/IDE layers are fabricated on top of the interfacial SiO₂ layer and the silicon substrate (e.g., an inversion-symmetric material). As a result, the selective presence of the centrosymmetric substrate in the regions of interest on the FET device not only provides the mechanism for interface SHG but also provides a highly selective measurement localized to this region of interest. Such interface SHG metrology as disclosed herein may thus provide sensitive and selective measurements that may be directly correlated to device performance.

Some embodiments of the present disclosure are directed to various SHG metrology techniques or measurement modes. In some embodiments, an illumination beam is directed to a sample (e.g., including a FET device) and SHG light is captured using a detector and a filter to isolate the SHG signal (e.g., a bandpass filter). The illumination beam may generally be directed to the sample at any angle including a normal incidence angle or an off-axis incidence angle. In some embodiments, the sample is further exposed to additional stimuli to enhance the SHG signal and thus the signal to noise ratio (SNR) of the measurement. For example, the sample may be simultaneously illuminated with another light source and/or an electric field to excite the dipoles in the IDE layer during a measurement. In some embodiments, a time-domain SHG signal (TD-SHG) is measured. For example, the temporal evolution of the SHG signal in response to the incident illumination and/or the additional stimuli may be measured to provide additional information about the IDE layer and the associated dipoles. In some embodiments, SHG signals associated with different wavelengths of incident illumination are measured. It is contemplated herein that a penetration depth of incident illumination into a multi-channel FET device may vary based on the wavelength such that the different wavelengths of incident illumination may probe different depths of the FET.

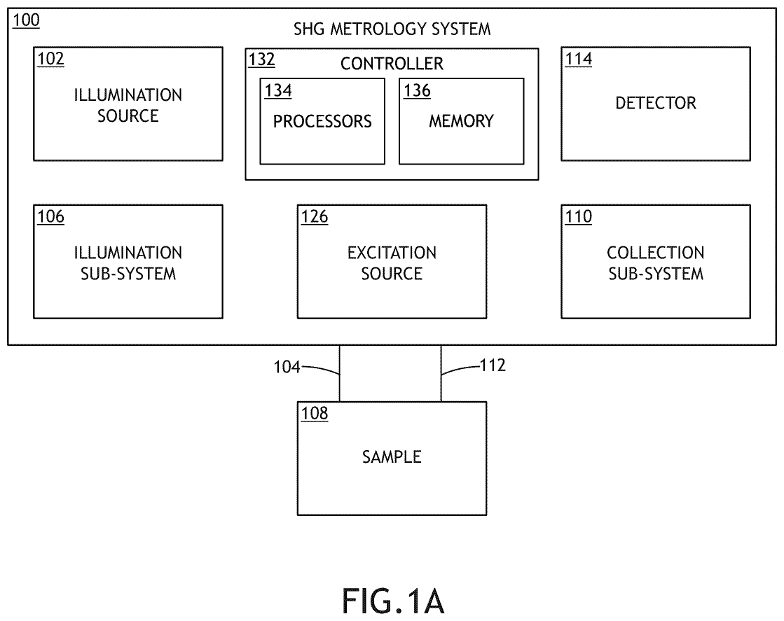

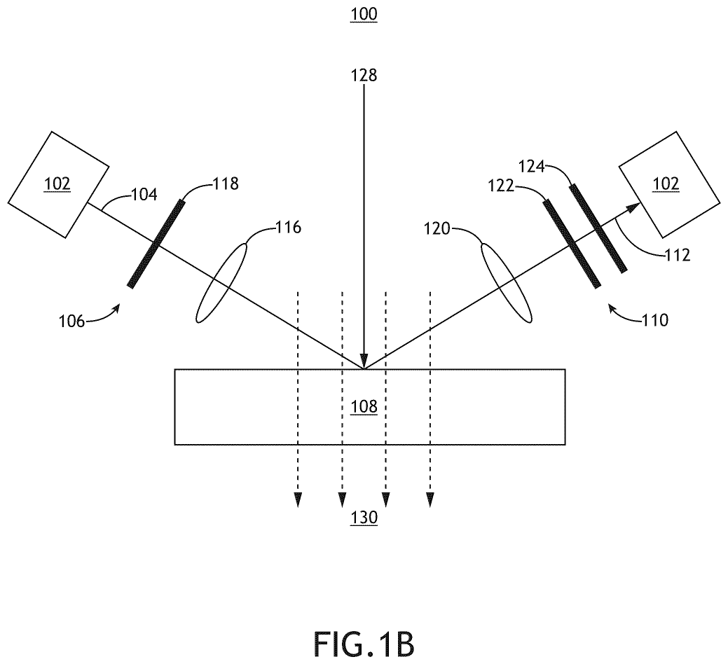

Referring now to FIGS. 1A-10, systems and methods for selective metrology using SHG are described in greater detail, in accordance with one or more embodiments of the present disclosure.

FIG. 1A is a block diagram of an SHG metrology system 100, in accordance with one or more embodiments of the present disclosure. FIG. 1B is a simplified schematic of an SHG metrology system 100, in accordance with one or more embodiments of the present disclosure.

In some embodiments, the SHG metrology system 100 includes an illumination source 102 configured to generate an illumination beam 104, an illumination sub-system 106 including one or more optical elements to direct the illumination beam 104 to a sample 108, a collection sub-system 110 including one or more optical elements to direct SHG light 112 generated by the sample 108 in response to the illumination beam 104 to a detector 114. For example, the spectrum of the SHG light 112 may have twice the frequency or half the wavelength of the spectrum of the illumination beam 104.

The illumination source 102 may be any light source known in the art suitable for generating an illumination beam 104 suitable for inducing SHG light 112 in the sample 108. In some embodiments, the illumination source 102 is a laser source such that the illumination beam 104 is a coherent laser beam.

The illumination beam 104 may further have any selected spectral content. For example, the illumination beam 104 may have a selected wavelength (or center wavelength) in any spectral range such as, but not limited to, ultraviolet (UV), visible, infrared (IR), or near-IR. In some embodiments, the illumination source 102 may include a laser source. In some embodiments, the illumination source 102 is a tunable source (e.g., a tunable laser source or a tunable non-laser source). In this way, the illumination beam 104 may have a tunable wavelength, center wavelength, or spectra more generally. For example, the illumination source 102 may include, but is not limited to, a Ti:Sapphire laser source or a Yb-KGW laser source.

The illumination beam 104 may generally have any temporal profile. In some embodiments, the illumination beam 104 is formed as a series of pulses. Such pulses may have any pulse duration. As a non-limiting example, the illumination beam 104 may have pulse durations on the order of picoseconds, femtoseconds, or attoseconds, which are commonly referred to as ultrashort pulses. Such ultrashort pulses may beneficially provide high peak powers suitable for efficiently inducing SHG in the sample 108. Such pulses may also have any repetition rate such as, but not limited to, a repetition rate in the range of kHz to MHz.

The illumination sub-system 106 may include any combination of optical components suitable for directing the illumination beam 104 to the sample 108 and/or controlling properties of the illumination beam 104. For example, the illumination sub-system 106 may include one or more lenses 116 to control a spot size of the illumination beam 104 on the sample 108. As another example, the illumination sub-system 106 may include one or more illumination-controlling components 118 to control parameters of the illumination beam 104 such as, but not limited to, intensity, wavelength (or spectrum more generally), polarization, spot size on the sample 108, or angle of incidence on the sample 108. For example, the illumination-controlling components 118 may include, but are not limited to, one or more polarizers, one or more spectral filters, one or more spatial filters, or one or more apodizers. Such illumination-controlling components 118 may be placed at any suitable location including, but not limited to, a pupil plane or a field plane. Further, the illumination sub-system 106 may direct the illumination beam 104 to the sample at any incidence angle including a normal incidence angle (e.g., as depicted in FIG. 1B) or an off-axis incidence angle.

The collection sub-system 110 may include any combination of optical components suitable for directing SHG light 112 from the sample 108 to the detector 114. In some embodiments, the collection sub-system 110 includes one or more lenses 120 to collect light from the sample 108. In some embodiments, the collection sub-system 110 includes one or more collection-controlling components 122 to control parameters of collected light such as, but not limited to, intensity, wavelength (or spectrum more generally), polarization, collection location on the sample 108, or angle of collection. For example, the collection-controlling components 122 may include, but are not limited to, one or more polarizers, one or more spectral filters, one or more spatial filters, or one or more apodizers.

In some embodiments, the collection sub-system 110 (e.g., the collection-controlling components 122) includes a filter 124 to selectively pass the SHG light 112 to the detector 114 or at least block reflected light associated with the spectrum of the illumination beam 104. For example, the filter 124 may include one or more spectral filters (e.g., dielectric filters, or the like) such as, but not limited to, a bandpass filter to selectively pass the SHG light 112, a band reject filter to selectively reject the spectrum of the illumination beam 104, or a low-pass filter (e.g., a low-pass wavelength filter) with a cutoff to block the spectrum of the illumination beam 104 and pass the spectrum of the SHG light 112. As another example, the filter 124 may include a dispersive element to spectrally disperse light emanating from the sample 108 followed by a spatial filter to selectively pass the SHG light 112.

In some embodiments, various components of the illumination sub-system 106 and the collection sub-system 110 are coupled or operated in tandem. For example, the SHG process is dependent on the polarization of the illumination beam 104. Accordingly, the illumination sub-system 106 may include a polarizer (e.g., one of the illumination-controlling components 118) configured to provide a polarization of the illumination beam 104 that maximizes an intensity of the SHG light 112. The collection sub-system 110 may then include a polarizer (e.g., one of the collection-controlling components 122) configured to isolate the filter 124 with the associated polarization.

The detector 114 may include any component or combination of components suitable for detecting the SHG light 112 and providing measurement data associated with the SHG light 112. In some embodiments, the detector 114 includes a single-pixel device such as, but not limited to, a photodetector, an avalanche photodiode, or a photo-multiplier tube. In some embodiments, the detector 114 includes a multi-pixel device such as, but not limited to, a charge-coupled device (CCD) or a complementary metal-oxide-semiconductor (CMOS) device. In some embodiments, the detector 114 includes a spectrometer suitable for measuring a spectrum of light emanating from the sample 108 in response to the illumination beam 104. In a general, the SHG metrology system 100 may include any number or types of detectors 114. In this way, the SHG metrology system 100 may more generally be suitable for additional measurements beyond SHG measurements such as, but not limited to, Raman spectroscopy or photoluminescence.

In some embodiments, the SHG metrology system 100 includes one or more excitation sources 126 to enhance SHG generation by the illumination beam 104. The excitation sources 126 may include any type of source suitable for enhancing SHG generation associated with the illumination beam 104 such as, but not limited to, an additional illumination source or an electric field source.

In some embodiments, an excitation source 126 includes an additional illumination source configured to generate an additional illumination beam 128. In this configuration, the SHG metrology system 100 may direct the additional illumination beam 128 to the same portion of the sample 108 at the same or a different illumination angle as the illumination beam 104. For example, FIG. 1B depicts an additional illumination beam 128 incident on the sample 108 at a normal incidence angle. As a result, the additional illumination beam 128 may generate charge separation at one or more interfaces of the sample 108 and thus induce a DC electric field, which may contribute to the SHG process and may thus increase the intensity of the SHG light 112.

In some embodiments, an excitation source 126 includes an electric field source (not explicitly shown in FIG. 1B) configured to generate an electric field 130. For example, the electric field 130 may be oriented perpendicular to a surface of the sample 108 to modify the SHG behavior of the sample 108. It is recognized that electric-filed-induced second harmonic generation (EFISH) is a third-order nonlinear process depending on the interaction between the electric field and incident photons. In some embodiments, a DC electric field 130 is applied to a symmetry-broken surface to enhance the generation of interface SHG light 112 associated with the illumination beam 104. In particular, the SHG light 112 may be generated by interface SHG processes and enhanced by the contribution of third-order electric susceptibility due to the external electric field 130. It is contemplated herein that EFISH techniques have been utilized generally to analyze material properties, but not for surface-selective SHG metrology as disclosed herein.

In some embodiments, the overlay metrology system 100 further includes a controller 132 with one or more processors 134 configured to execute program instructions maintained on memory 136 (e.g., a memory medium). The controller 132 may be communicatively coupled with any of the components of the SHG metrology system 100 such as, but not limited to the detector 114. In this way, the controller 132 may receive metrology data from the detector 114 associated with SHG light 112 from the sample 108 generate one or more metrology measurements associated with the sample (e.g., films near an interface with an inversion-symmetric substrate) based on the metrology data (e.g., in accordance with a metrology recipe).

The one or more processors 134 of a controller 132 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 134 may include any device configured to execute algorithms and/or instructions (e.g., program instructions stored in memory). In one embodiment, the one or more processors 134 may be embodied as a desktop computer, mainframe computer system, workstation, image computer, parallel processor, networked computer, or any other computer system configured to execute a program configured to operate or operate in conjunction with the overlay metrology system 100, as described throughout the present disclosure.

Moreover, different subsystems of the overlay metrology system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller 132 or, alternatively, multiple controllers. Additionally, the controller 132 may include one or more controllers housed in a common housing or within multiple housings. In this way, any controller or combination of controllers may be separately packaged as a module suitable for integration into the overlay metrology system 100.

The memory 136 may include any storage medium known in the art suitable for storing program instructions executable by the associated one or more processors 134. For example, the memory 136 may include a non-transitory memory medium. By way of another example, the memory 136 may include, but is not limited to, a read-only memory (ROM), a random-access memory (RAM), a magnetic or optical memory device (e.g., disk), a magnetic tape, a solid-state drive and the like. It is further noted that the memory 136 may be housed in a common controller housing with the one or more processors 134. In one embodiment, the memory 136 may be located remotely with respect to the physical location of the one or more processors 134 and controller 132. For instance, the one or more processors 134 of the controller 132 may access a remote memory (e.g., server), accessible through a network (e.g., internet, intranet and the like).

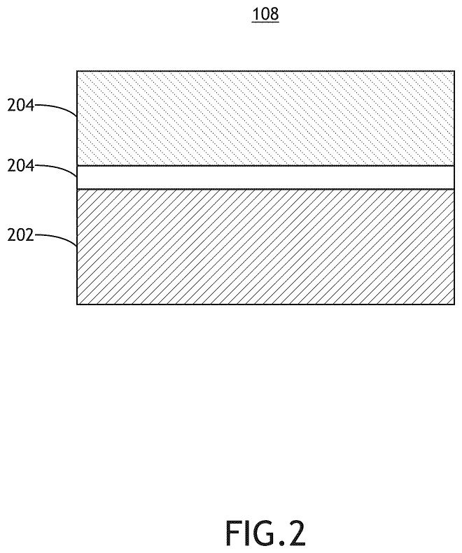

Referring now to FIGS. 2-8, interface SHG for thin film metrology is described in greater detail, in accordance with one or more embodiments of the present disclosure.

FIG. 2 includes side views of a schematic of a sample 108 suitable for interface SHG metrology, in accordance with one or more embodiments of the present disclosure.

In some embodiments, the sample 108 includes an inversion-symmetric substrate 202 and one or more films 204 (e.g., thin films) of material to be characterized disposed on the inversion-symmetric substrate 202.

The inversion-symmetric substrate 202 may include any type of material known in the art possessing inversion symmetry such as, but not limited to, a centrosymmetric material (e.g., a centrosymmetric crystal) or an isotropic material (e.g., a glass). In this way, SHG may be zero or weak within the bulk of the inversion-symmetric substrate 202. Further, the inversion-symmetric substrate 202 may have any material phase, such as, but not limited to, crystal, glass, or ceramic. In some embodiments, the inversion-symmetric substrate 202 is reflective for the wavelengths of at least the SHG light 112 such that the SHG light 112 is reflected from the sample 108 and collected by a collection sub-system 110 on a common side of the sample 108 as the illumination sub-system 106. In some embodiments, the inversion-symmetric substrate 202 includes a crystalline semiconductor substrate such as, but not limited to, silicon.

The one or more films 204 may include any type of material known in the art. In some embodiments, the one or more films 204 are also inversion-symmetric. In some embodiments, the one or more films 204 include SiO₂ (e.g., an IL) and/or a high-k material such as, but not limited to SisN₄, Al₂O₃, Ta₂O₅, TiO₂, ZrO₂, HfO₂, HfSiₓO_{y}, or HfOₓN_{y}.

It is contemplated herein that interface SHG may be suitable for thin film metrology of a wide variety of devices and materials (e.g., features on a sample 108). For example, a sample 108 suitable for interface SHG metrology may include ferroelectric random-access memory (FeRAM) and ferroelectric FET devices. As an illustration, a sample 108 may include such ferroelectric thin film stacks may include one or more HfO₂ films 204 doped with materials such as, but not limited to, Zr, Al, Gd, La, Si, Sr and Y. As another illustration, a sample 108 may include one or more of HfO₂ films 204 with oxides such as, but not limited to, SiO₂/HfO₂/AlO₃ or HfO₂/ZrO₂/HfO₂. As another example, interface SHG may be used to measure various aspects of 2D materials such as, but not limited to, the layer number, thickness, or the presence of defects. As an illustration, a sample 108 may include transition-metal dichalcogenides such as, but not limited to, MoS₂, MoSe₂, MoTe₂, WS₂ or WSe₂. As another illustration, a sample 108 may include III-IV chalcogenides such as, but not limited to InSe or GaSe.

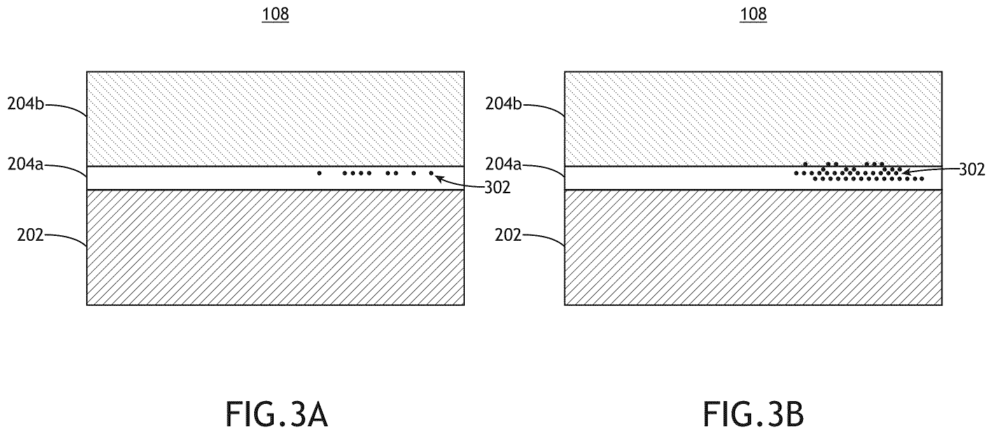

FIGS. 3A and 3B are side views of a thin film stack formed from materials common to at least some FET devices. In particular, FIG. 3A is a side view schematic of an inversion-symmetric substrate 202 formed from silicon with a first film 204a formed as an IL of SiO₂ and a second film 204b formed as a high-k material (e.g., an annealed high-k material), in accordance with one or more embodiments of the present disclosure. FIG. 3B is a side view schematic of the materials in FIG. 3A after an IDE process, in accordance with one or more embodiments of the present disclosure.

As depicted in FIG. 3A an interface associated with the films 204 on the inversion-symmetric substrate 202 may have electric dipoles 302 that may contribute to interface SHG. The electric dipoles 302 in FIG. 3A may be primarily associated with the breakage of inversion symmetry at the interface. In FIG. 3B, the interface may have additional electric dipoles 302 associated with the IDE layer that may further contribute to the interface SHG process. In this way, interface SHG may be suitable for characterizing the various materials associated with the interface including, but not limited to the IDE electric dipoles 302 associated with the IDE process.

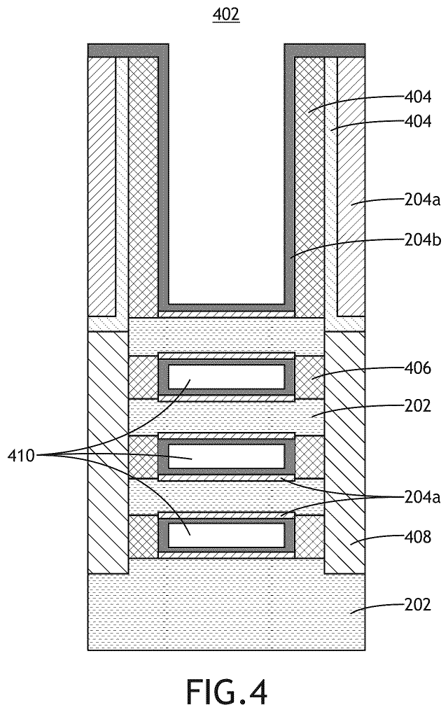

Referring now to FIG. 4, the use of interface IHG for surface-selective metrology is described in greater detail, in accordance with one or more embodiments of the present disclosure.

FIG. 4 is a schematic side view of a gate region of a multi-channel FET 402, in accordance with one or more embodiments of the present disclosure. In FIG. 4, the FET 402 includes a series of vertically-distributed silicon substrates coated with IL SiO₂ layers and high-k/IDE layers.

The performance of the FET 402 (e.g., the Vₜ value) may be highly sensitive to and controlled by the particular characteristics of the high-k/IDE layers in the gate channel regions (e.g., the generation of electric dipoles 302 in these regions) and much less sensitive to the particular characteristics of the high-k/IDE layers in other areas of the FET 402. It is further contemplated herein that the gate channel regions of the FET 402 beneficially have the structure depicted in FIG. 3B. In particular, these regions include various interfaces of inversion-symmetric substrate 202 (e.g., the silicon substrates) coated with IL and high-k/IDE films 204 as depicted in FIG. 3B. As a result, such regions may generate interface SHG light 112 with measurable properties that relate to the electric dipoles 302 in these interface regions. The measured properties of the SHG light 112 from these regions may not only characterize the physical properties Si/IL/high-k/IDE interface regions, but may also directly relate to operational properties of FET 402 (e.g., the Vₜ value).

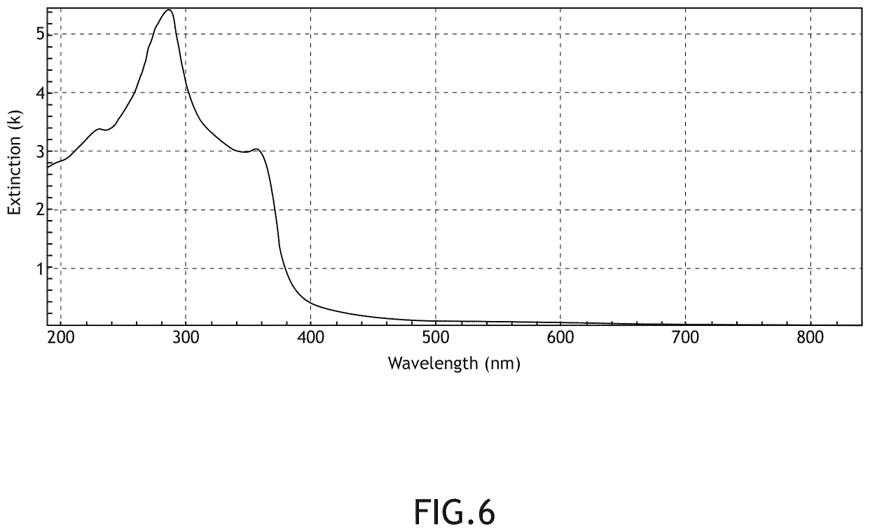

Additionally, although the high-k/IDE layers may be present in various additional parts of the FET 402 (e.g., gate spacers 404, inner spacers 406, or source/drain EPI regions 408 in various configurations), such additional parts of the FET 402 lack the specific Si/IL/high-k/IDE interface and thus may exhibit substantially different interface SHG properties. Thus, the SHG light 112 from the gate channel regions of interest may be distinguished from SHG light 112 (if present) from other regions to provide surface-selective metrology of these regions of interest. Further, as will be described in greater detail with respect to FIGS. 6-8, the SHG light 112 from individual channels 410 or interfaces therein may be separately distinguished (e.g., identified, separated, or the like) to provide selective measurements of the properties of each channel 410.

Referring generally to FIG. 4, it is to be understood that FIG. 4 and the associated description is provided solely for illustrative purposes and should not be interpreted as limiting. Rather, interface SHG may be used for surface-selective thin film metrology of any suitable interface between an inversion-symmetric substrate 202 and one or more proximate films 204.

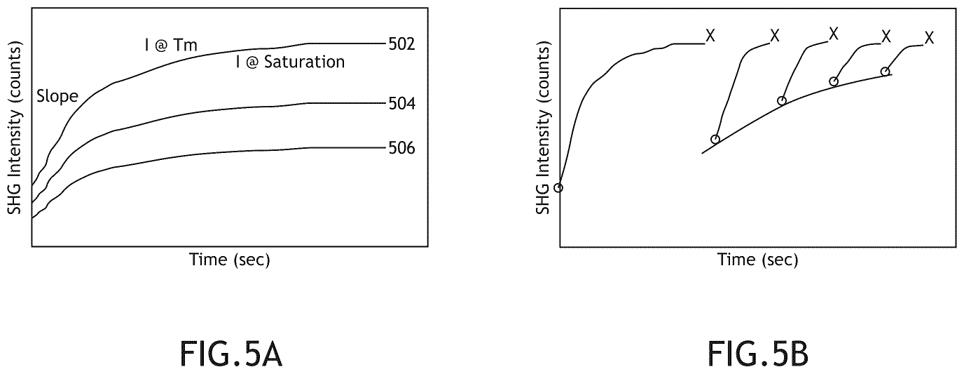

Referring now to FIGS. 5A-8, various interface SHG measurements (or measurement modes) are described in greater detail, in accordance with one or more embodiments of the present disclosure. Such measurements may be performed with, but are not limited to, the SHG metrology system 100 depicted in FIGS. 1A-1B.

FIG. 5A is a simulated plot of the intensity of SHG light 112 as a function of time for different variations of a sample 108 represented by lines 502, 504, 506, in accordance with one or more embodiments of the present disclosure. Such regions may generally correspond to variations of a thin film stack (e.g., as depicted in FIG. 3B) such as, but not limited to, composition variations, thickness variations, IDE variations, or surface roughness variations. As depicted in FIG. 5A, the intensity of interface SHG light 112 may generally exhibit a rapid rise followed by saturation at a saturation intensity.

It is contemplated herein that metrology data associated with an interface between films 204 of interest and an inversion-symmetric substrate 202 may be generated based on any aspect of SHG light 112 measurable by a detector 114 based on illumination of the sample 108 with an illumination beam 104 with or without additional excitation from an excitation source 126 (e.g., an additional illumination beam 128, an electric field 130, or the like).

In some embodiments, metrology data associated with an interface between films 204 of interest and an inversion-symmetric substrate 202 is generated based on a saturation intensity of the SHG light 112. For example, the saturation intensity may correspond to a number of electric dipoles 302 introduced by an IDE process and/or a thickness of an IDE layer. As one non-limiting illustration, in an application in which the composition and thickness of an IL and/or a high-k layer are well-known, the different saturation intensities depicted by lines 502-506 may correspond to different IDE layer thicknesses (and corresponding numbers of generated electric dipoles 302).

In some embodiments, metrology data associated with an interface between films 204 of interest and an inversion-symmetric substrate 202 is generated based on temporal characteristics of the SHG light 112 such as, but not limited to, an initial slope of the intensity, an intensity of the SHG light 112 at any particular time (I @Tm in FIG. 5A), an intensity of the SHG light 112 at a saturation point (I @ Saturation in FIG. 5A), or a time required to reach a saturation intensity. For example, time dependent SHG (TD-SHG) plots such as those depicted in FIG. 5A can provide information about the properties such as, but not limited to, charges and traps produced from thin film stack adjacent to an interface with the inversion-symmetric substrate 202, which may further facilitate determination of properties such as, but not limited to, thin film thickness, compositions, electronic structures, defects, or surface/interface roughness. Further, such TD-SHG plots may provide metrology data associated with photon induced charge trapping and dopant level, carrier dynamics, and interface local fields. It is contemplated herein that such measurements may be unachievable with conventional electrical measurements.

FIG. 5B is a simulated plot of the intensity of SHG light 112 as a function of time for as a result of intermittent exposure (e.g., cycling) of the sample 108 to SHG conditions, in accordance with one or more embodiments of the present disclosure. In FIG. 5B, conditions for generating the SHG light 112 such as, but not limited to, the illumination beam 104 and/or excitation sources (e.g., an additional illumination beam 128, an electric field 130, or the like) are cycled on and off. For example, the illumination beam 104 and/or excitation sources are turned off at times marked with an “X” in FIG. 5B and turned on at times marked with an “O.” Such plots may be suitable for, but not limited to, measuring charge mobility within the sample 108, which may provide insight about device clock performance, reliability, or the like. As an illustration, the initial intensity of the SHG light 112 for the different cycles increases in FIG. 5B indicating information about the lifetimes of excited states.

As an illustration in the case of cycling an electric field 130 and a sample 108 with a Si/SiO₂/high-k/IDE stack (e.g., as depicted in FIG. 3B), charges and traps may be generated by any combination of IDE doping into the high-k film 204, an additional illumination beam 128 if present, or the primary illumination beam 104. The presence of the external electric field 130 may then excite electrons in the silicon valence band by a three-photon excitation process. This may leave a hole state such that an excited electron can drift through the oxide conduction band. The remaining holes in the silicon valence band and the electrons may then be captured by oxygen molecules from the SiO₂ IL to create a capacitor-like structure that will generate a DC electric field across the SiO₂ IL, which may in turn impact properties of the interface SHG light 112. As an illustration, for a Si/SiO₂/HK/IDE sample 108 with different IDE concentrations, the charge and trap density at the SiO₂ IL may be different, which results in differences in the DC electric field in the presence of the external electric field 130 and corresponding differences in the resulting SHG light 112. Such an approach is called as electrical field induced SHG (EFISH).

In a general sense, however, a time-dependent SHG plot such as that illustrated in FIG. 5B may be generated by cycling the illumination source 102, maintaining the illumination source 102 but cycling an additional illumination beam 128 and/or an electric field 130, or cycling any combination of these.

Referring now to FIGS. 6-8, depth-dependent interface SHG signals using wavelength tuning is described in greater detail, in accordance with one or more embodiments of the present disclosure.

It is contemplated herein that depth-dependent interface SHG information may be generated by controlling the wavelength of the illumination beam 104 (and thus the generated SHG light 112 at half the wavelength of the illumination beam 104) relative to the extinction properties of the sample 108. In particular, the extinction characteristics of the sample 108 may limit both the initial penetration depth of the illumination beam 104 into the sample 108 as well as the degree to which SHG light 112 generated below a surface may propagate out of the surface for detection.

FIG. 6 is a plot of the optical extinction coefficient (k) as a function of wavelength for silicon (e.g., a common inversion-symmetric substrate 202 for semiconductor applications), in accordance with one or more embodiments of the present disclosure. As depicted in FIG. 6, silicon is generally transparent at wavelengths above 380 nm and has an extinction peak around 290 nm.

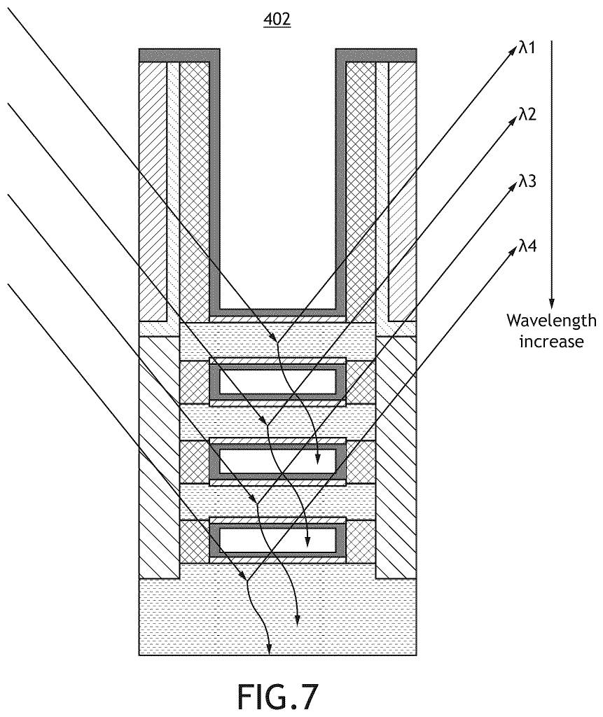

FIG. 7 is a schematic side view of a gate region of the multi-channel FET 402 of FIG. 4 further depicting wavelength-dependent interface SHG measurements, in accordance with one or more embodiments of the present disclosure. In FIG. 7, wavelengths with increasing wavelength are illustrated as penetrating deeper into the FET 402. In particular, FIG. 7 depicts interaction of the illumination beam 104 with various channels 702 at different depths.

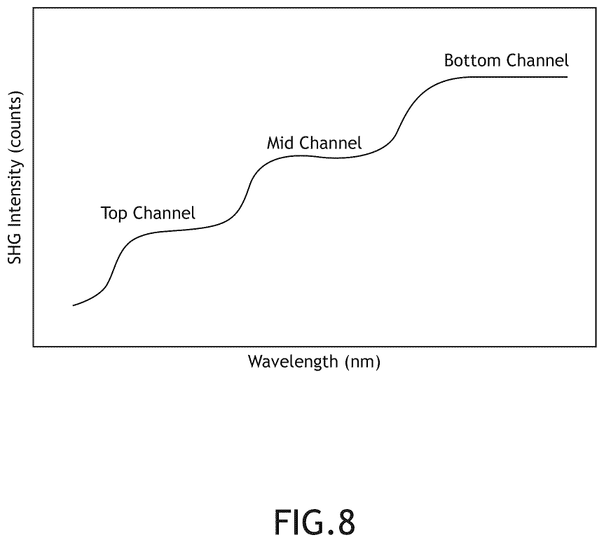

FIG. 8 is a simplified simulation of the intensity trend of interface SHG in the FET 402 as a function of wavelength, in accordance with one or more embodiments of the present disclosure.

As shown in FIGS. 6 and 7, increasing the wavelength of the illumination beam 104 may result in both increasing penetration of the illumination beam 104 and increased transmittance of the SHG light 112 at half the wavelength. In the case of silicon, the effect of increasing wavelength is particularly pronounced when the wavelength of the SHG light 112 is approximately 290 nm (e.g., associated the peak extinction coefficient in FIG. 6) and greater.

Further, as depicted in FIG. 7, SHG light 112 may be generated at multiple interfaces (particularly the surface-selective interfaces between an inversion-symmetric substrate 202 and films 204 of interest associated with one or more channels 702 as described herein) within a given penetration depth. As a result, the intensity of SHG light 112 may generally be based on the cumulative emission from the interfaces within the penetration depth. As a result, various depth-based metrology measurements are possible.

In some embodiments, depth-dependent metrology data is generated based on scanning a wavelength of the illumination beam 104 (and thus the wavelength of the SHG light 112) through a region in which the extinction of the illumination beam 104 and/or the SHG light 112 varies. In this way, increasing the wavelength will successively provide increasing SHG light 112 as additional interfaces of interest are characterized. As an illustration, FIG. 8 depicts increasing SHG light 112 as a function of wavelength and further depicts distinct plateaus of the SHG light 112 associated with the various channels 702 in the FET 402. In this way, the trend of the SHG light 112 as a function of wavelength may provide specific information related to the structure of the FET 402. Further, gathering cumulative information about the various interfaces enables quantitative metrology measurements of each interface and/or each channel 702.

In some embodiments, metrology data may be generated based on measurements of SHG light 112 at a particular selected wavelength. For example, it may not be desirable to perform a wavelength scan in some applications for reasons of measurement efficiency, or the like. In this case, metrology data associated with a measurement of SHG light 112 at a known wavelength associated with a known penetration depth may provide cumulative or average information of all interfaces of interest within the penetration depth. As an illustration, a selected wavelength known to probe all three channels of the FET 402 (e.g., a wavelength in the plateau region associated with the bottom channel as shown in FIG. 8) may provide information about all three channels. For instance, such data may be used to provide average data for the interfaces within the penetration depth, where extinction as a function of depth may be taken into account as necessary. Further, additional assumptions or knowledge about the various channels and/or the extinction trends as a function of depth may be used to generate specific information about any of the interfaces of interest.

It is to be understood that FIGS. 6-8 and the associated descriptions are provided solely for illustrative purposes and should not be interpreted as limiting. Rather, the concepts disclosed herein may be extended to any type of sample 108 with any type of structures or combinations of materials.

Further, referring generally to FIGS. 5A-8, metrology data related to interfaces of interest in a sample 108 may be generated using any combination of time-domain and wavelength-domain measurements. For example, time-domain measurements may be generated for any number of wavelengths.

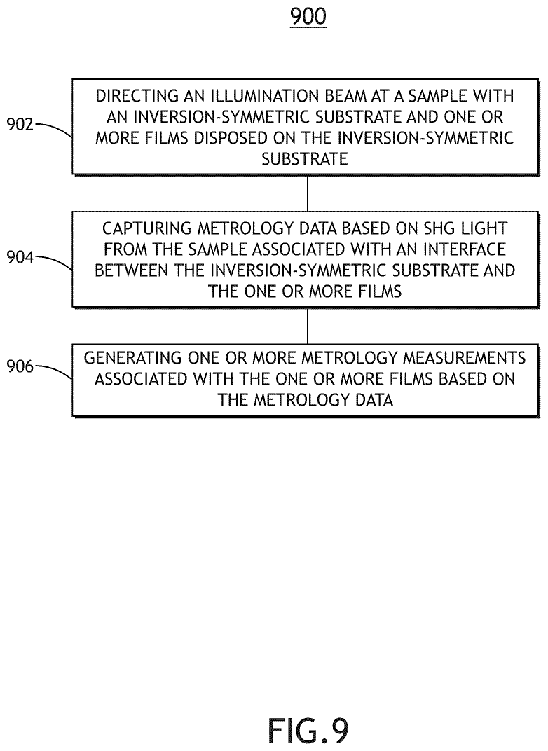

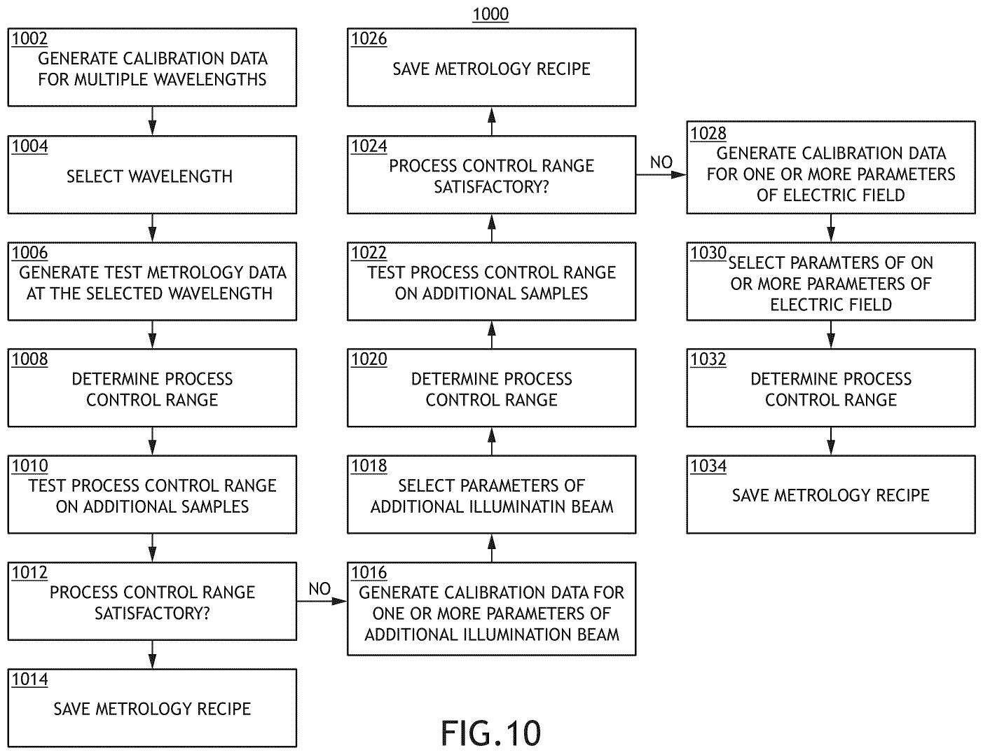

Referring now to FIGS. 9 and 10, methods for performing interface SHG measurements are described in greater detail.

FIG. 9 is a flow diagram illustrating steps performed in a method 900 for interface SHG metrology, in accordance with one or more embodiments of the present disclosure. The Applicant notes that the embodiments and enabling technologies described previously herein in the context of the SHG metrology system 100 should be interpreted to extend to the method 900. It is further noted, however, that the method 900 is not limited to the architecture of the SHG metrology system 100.

In some embodiments, the method 900 includes a step 902 of directing an illumination beam 104 at a sample 108 with an inversion-symmetric substrate 202 and one or more films 204 disposed on the inversion-symmetric substrate 202. In some embodiments, the method 900 includes a step 904 of capturing metrology data based on SHG light 112 from the sample 108 associated with an interface between the inversion-symmetric substrate 202 and the one or more films 204. For example, the steps 902 and 904 may be, but are not required to be, performed using the SHG metrology system 100 as illustrated in FIGS. 1A-1B. Further, the steps 902 and 904 may be performed using any suitable technique. For example, the illumination beam 104 may be scanned across the sample 108 or may be stationary during a measurement. As an illustration, though not explicitly illustrated in FIG. 1B, the illumination beam 104 may be scanned with respect to the sample 108 using beamscanning optics (e.g., galvo mirrors, or the like) and/or the sample 108 may be translated with respect to the illumination beam 104 using one or more translation stages.

In some embodiments, the method 900 includes a step 906 of generating one or more metrology measurements associated with the one or more films 204 based on the metrology data. As described previously herein, SHG light 112 may be generated based on the interface between an inversion-symmetric substrate 202 and one or more films 204 of interest due to a break of inversion symmetry at the interface. It is contemplated herein that the properties of the SHG light 112 (e.g., amplitude, temporal characteristics, or the like) may be sensitive to electric dipoles 302 in the one or more films 204 adjacent to the interface. In this way, the SHG light 112 may provide an indirect metrology measurement of the properties of these adjacent films 204 such as, but not limited to, layer thickness, layer composition, the presence of defects, charge/trap states, stress/strain, charge mobility, or surface/interface roughness. As an non-limiting illustration in the case of a FET (e.g., the multi-channel FET 402 depicted in FIG. 4), the metrology measurements may be associated with such properties of high-k/IDE films 204 adjacent to an inversion-symmetric substrate 202 (e.g., silicon, or the like). In some embodiments, the metrology measurements generated in step 906 are associated with operational and/or performance characteristics of a functional device. Continuing the illustration of the multi-channel FET 402 depicted in FIG. 4, the metrology data may include at least one of a measurement of a value of Vₜ or a value predictive of Vₜ. For instance, the value of Vₜ of the FET 402 when fully fabricated may be directly impacted by electric dipoles 302 in the high-k/IDE films 204 in the gate/channel region such that metrology measurements generated in step 906 based on SHG light 112 at the interface between these films 204 and the inversion-symmetric substrate 202 may be used to either directly estimate the value of Vₜ or provide a value indicative of Vₜ suitable for process control.

Further, the properties of the SHG light 112 may be highly specific to the particular interface and may thus provide surface-selective metrology at these interfaces. In some embodiments, the metrology measurements generated in step 906 are based on SHG light 112 identified as being associated with an interface of interest. For example, the method 900 may include identifying regions of interest on a sample 108 based on the SHG light 112 captured in the step 904 and using the associated SHG light 112 to generate surface-selective metrology measurements. As a non-limiting illustration in the case of the multi-channel FET 402 as depicted in FIG. 4, the properties of the SHG light 112 (e.g., the intensity, the temporal properties, the wavelength-specific properties, or any combination thereof) may be distinguishable in the gate/channel region depicted in FIG. 4 based on the selective presence of the inversion-symmetric substrates 202 coated with the high-k/IDE layers in that region and not in other reasons. In some embodiments, design data associated with the sample 108 may be used in addition or in the alternative to identify SHG light 112 from the regions of interest for generation of the metrology measurements.

In some embodiments, the method further includes a step of controlling one or more fabrication processes based on the metrology data. Such control may include any combination of feedback control (e.g., for controlling fabrication processes on additional samples 108 in a lot) or feed-forward control (e.g., for controlling fabrication processes on the same sample 108 to compensate for measured variations). Continuing the illustration of the multi-channel FET 402 as depicted in FIG. 4, the method may include controlling processes associated with fabricating the high-k and/or IDE films 204 based on metrology measurements associated with the electric dipoles 302 in the gate region of a FET (e.g., a FET 402) based on the SHG light 112 from those regions.

In some embodiments, metrology measurements based on SHG light 112 (or metrology data from a detector 114 indicative of such SHG light 112) are generated in part with calibration metrology data associated with known variations of the interface between the inversion-symmetric substrate 202 and the one or more films 204. For example, the method 900 may include fabricating one or more calibration samples having known variations of the interface between the inversion-symmetric substrate 202 and the one or more films 204 to provide a design of experiments (DOE). As an illustration, the DOE may provide variations of a FET 402 with known variations of the IDE process, thicknesses of any constituent parts, compositions of any constituent parts, or any other parameter. The method 900 may then include generating calibration metrology data of the one or more calibration samples (e.g., time-resolved and/or wavelength-resolved measurements of the SHG light 112 with or without an additional illumination beam 128 and/or an electric field 130) and correlating the metrology data with the known variations. In this way, quantitative metrology measurements for a new sample 108 with unknown parameters may be generated based on the metrology data from the new sample 108 and the calibration metrology data.

Referring now to FIG. 10, the generation of a metrology recipe is described in accordance with one or more embodiments of the present disclosure. A metrology recipe may generally describe various parameters of the SHG metrology system 100 during a measurement. In some embodiments, a metrology recipe includes various parameters associated with the illumination beam 104 such as, but not limited to, the intensity, wavelength, polarization, spot size on the sample 108, or incidence angle on the sample 108. In some embodiments, a metrology recipe includes various parameters associated with the collected SHG light 112 such as, but not limited to, the polarization. In some embodiments, a metrology recipe includes various parameters associated with the detector 114 such as, but not limited to, gain settings. In some embodiments, a metrology recipe includes various parameters associated with an excitation source 126 for enhancing the SHG process. For example, a metrology recipe may include various parameters associated with an additional illumination beam 128 such as, but not limited to, the intensity, wavelength, polarization, spot size on the sample 108, or incidence angle on the sample 108. As another example, a metrology recipe may include various parameters associated with an electric field 130 such as, but not limited to, an electric field strength or angle with respect to the sample 108.

FIG. 10 is a flow diagram for a method 1000 depicting the generation of a metrology recipe that meets application-specific requirements, in accordance with one or more embodiments of the present disclosure. The Applicant notes that the embodiments and enabling technologies described previously herein in the context of the SHG metrology system 100 should be interpreted to extend to the method 1000. It is further noted, however, that the method 1000 is not limited to the architecture of the SHG metrology system 100.

In some embodiments, the method 1000 includes a step 1002 of generating calibration data (e.g., associated with a DOE) for multiple wavelengths (e.g., of the illumination beam 104). For example, a common sample 108 may be measured with different wavelengths and the amplitude of the SHG light 112 may be measured for each case. In some embodiments, the method 1000 includes a step 1004 of selecting a wavelength. For example, the wavelength providing the highest or most optimal amplitude (e.g., within a tolerance) may be selected. In some embodiments, method 1000 includes a step 1006 of generating test metrology data at the selected wavelength. For example, the test metrology data may be generated on additional samples. In some embodiments, the method 1000 includes a step 1008 of determining a process control range. For example, the process control range may be associated with a range of allowable wavelengths to be used during a run-time measurement. In some embodiments, the method 1000 includes a step 1010 of testing the process control range on additional samples. For example, this may involve determining whether application-specific requirements (e.g., intensity of the SHG light 112 and associated signal to noise ratio, or the like) are met using the process control range on the additional samples. In some embodiments, the method 1000 includes a step 1012 of checking whether the process control range is satisfactory. If the application-specific requirements are met, the method 1000 includes a step 1014 of saving the metrology recipe such that it may be used during run-time.

If the application-specific requirements are not met, various additional steps may be taken to provide a metrology recipe that includes an additional excitation source 126 to enhance the SHG light 112 to meet the application-specific requirements. In some embodiments, the method 1000 includes a step 1016 of generating calibration data for one or more parameters of an additional illumination beam 128. Any suitable parameters may be considered such as, but not limited to, the intensity, wavelength, or polarization of the additional illumination beam 128. In some embodiments, the method 1000 includes a step 1018 of selecting the one or more parameters of the additional illumination beam 128 based on the calibration data. For example, the parameters providing the highest or most optimal amplitude (e.g., within a tolerance) may be selected. In some embodiments, the method 1000 includes a step 1020 of determining a process control range (e.g., for use during a run-time measurement). In some embodiments, the method 1000 includes a step 1022 of testing the process control range on one or more additional samples. In some embodiments, the method 1000 includes a step 1024 of determining whether the process-control range is satisfactory. If the application-specific requirements are met, the method 1000 includes a step 1026 of saving the metrology recipe such that it may be used during run-time.

If the application-specific requirements are not met, various additional steps may be taken to provide a metrology recipe that includes a different excitation source 126 to enhance the SHG light 112 to meet the application-specific requirements. In some embodiments, the method 1000 includes a step 1028 of generating calibration data for one or more parameters of an external electric field 130. Any suitable parameters may be considered such as, but not limited to, the strength or direction of the electric field 130. In some embodiments, the method 1000 includes a step 1030 of selecting the one or more parameters of the electric field 130 based on the calibration data. For example, the parameters providing the highest or most optimal amplitude (e.g., within a tolerance) may be selected. In some embodiments, the method 1000 includes a step 1032 of determining a process control range (e.g., for use during a run-time measurement). If the application-specific requirements are met, the method 1000 includes a step 1034 of saving the metrology recipe such that it may be used during run-time.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A metrology system, comprising:
an illumination source to generate an illumination beam;
an illumination sub-system including one or more optical elements configured to direct the illumination beam to a sample, wherein the sample includes an inversion-symmetric substrate and one or more films disposed on the inversion-symmetric substrate;
a filter configured to block a wavelength of the illumination beam and pass a wavelength associated with a second harmonic of the illumination beam;
a detector to capture second harmonic generation (SHG) light associated with the second harmonic of the illumination beam; and
a controller communicatively coupled to the detector, the controller including one or more processors configured to execute program instructions causing the one or more processors to:
receive metrology data from the detector associated with the SHG light from an interface between the inversion-symmetric substrate and the one or more films; and
generate one or more metrology measurements associated with the one or more films based on the metrology data.

2. The metrology system of claim 1, wherein the metrology measurement comprises:
at least one of layer thickness, layer composition, presence of defects, charge/trap states, stress/strain, charge mobility, or surface/interface roughness associated with at least one of the one or more films.

3. The metrology system of claim 1, wherein the interface between the inversion-symmetric substrate and the one or more films is associated with a gate region of a field effect transistor (FET).

4. The metrology system of claim 3, wherein the FET comprises:
at least one of a metal-oxide-semiconductor FET (MOSFET), a planar FET, a FinFET, a gate-all-around (GAA) nanosheet FET, a fork-sheet FET, a complimentary GAA FET, a ferroelectric FET, or a 2D FET.

5. The metrology system of claim 3, wherein the one or more films comprise:
at least one of a high-k layer or an interfacial dipole engineering layer.

6. The metrology system of claim 5, wherein the one or more films comprise:
at least one of Si₃N₄, Al₂O₃, Ta₂O₅, TiO₂, ZrO₂, or HfO₂.

7. The metrology system of claim 5, wherein the inversion-symmetric substrate comprises:
silicon.

8. The metrology system of claim 5, wherein at least one of the one or more metrology measurements comprises:
at least one of a threshold voltage (Vₜ) or a value indicative of the threshold voltage (Vₜ).

9. The metrology system of claim 5, wherein the one or more processors are further configured to execute program instructions causing the one or more processors to:
control one or more process tools for fabricating the at least one of the high-k layer or the interfacial dipole engineering layer based on the one or more metrology measurements.

10. The metrology system of claim 1, wherein the one or more processors are further configured to execute program instructions causing the one or more processors to:
control one or more process tools for fabricating at least a portion of the sample based on the one or more metrology measurements.

11. The metrology system of claim 1, wherein the metrology data from the detector associated with the second harmonic of the illumination beam comprises:
temporally-resolved measurements of the SHG light in response to illuminating the sample with the illumination beam, wherein at least one of the one or more metrology measurements are generated based on the temporally-resolved measurements of the SHG light.

12. The metrology system of claim 11, wherein at least one of the one or more metrology measurements is based on at least one of a saturation intensity of the SHG light, a slope of the intensity of the SHG light, or an intensity of the SHG light at a selected time.

13. The metrology system of claim 11, wherein the temporally-resolved measurements are associated with intermittent illumination of the sample with the illumination beam.

14. The metrology system of claim 11, wherein at least one of the one or more metrology measurements is based on intensity of the SHG light associated with the intermittent illumination of the sample with the illumination beam.

15. The metrology system of claim 1, wherein a wavelength of the illumination beam is tunable, wherein the metrology data from the detector associated with the second harmonic of the illumination beam comprises:
wavelength-resolved measurements of the SHG light in response to illuminating the sample with the illumination beam having two or more wavelengths, wherein at least one of the one or more metrology measurements are generated based on the wavelength-resolved measurements of the SHG light.

16. The metrology system of claim 15, wherein at least one of the one or more metrology measurements includes a depth-dependent measurement.

17. The metrology system of claim 1, further comprising:
one or more excitation sources to direct at least one of an additional illumination beam or an electric field to the sample to enhance the SHG light associated with the interface between the inversion-symmetric substrate and the one or more films.

18. The metrology system of claim 17, wherein the metrology data from the detector associated with the second harmonic of the illumination beam comprises:
temporally-resolved measurements of the SHG light in response to illuminating the sample with at least one of the additional illumination beam or the electric field, wherein at least one of the one or more metrology measurements are generated based on the temporally-resolved measurements of the SHG light.

19. The metrology system of claim 18, wherein the temporally-resolved measurement is associated with intermittent illumination of the sample with at least one of the additional illumination beam or the electric field while the illumination beam is constant.

20. The metrology system of claim 18, wherein the temporally-resolved measurement is associated with intermittent illumination of the sample with the illumination beam and the at least one of the additional illumination beam or the electric field.

21. The metrology system of claim 1, further comprising:
a first polarizer to control a polarization of the illumination beam incident on the sample; and
a second polarizer to control a polarization of light incident on the detector.

22. The metrology system of claim 21, wherein an orientation of at least one of the first polarizer or the second polarizer is adjusted to maximize an intensity of the second harmonic of the illumination beam within a selected tolerance.

23. The metrology system of claim 1, wherein the detector comprises:
at least one of a photo-multiplier tube, a charge-coupled device, or a photodiode.

24. A metrology system, comprising:
a controller including one or more processors configured to execute program instructions causing the one or more processors to:
receive metrology data from a detector associated with second harmonic generation (SHG) light from a sample in response to an illumination beam, wherein the sample includes an inversion-symmetric substrate and one or more films disposed on the inversion-symmetric substrate; and
generate one or more metrology measurements associated with the one or more films based on the SHG light associated with an interface between the inversion-symmetric substrate and the one or more films.

25. The metrology system of claim 24, wherein the metrology measurement comprises:
at least one of layer thickness, layer composition, presence of defects, charge/trap states, stress/strain, charge mobility, or surface/interface roughness associated with at least one of the one or more films.

26. The metrology system of claim 24, wherein the interface between the inversion-symmetric substrate and the one or more films is associated with a gate region of a field effect transistor (FET).

27. The metrology system of claim 26, wherein the FET comprises:
at least one of a metal-oxide-semiconductor FET (MOSFET), a planar FET, a FinFET, a gate-all-around (GAA) nanosheet FET, a fork-sheet FET, a complimentary GAA FET, a ferroelectric FET, or a 2D FET.

28. The metrology system of claim 26, wherein the one or more films comprise:
at least one of a high-k layer or an interfacial dipole engineering layer.

29. The metrology system of claim 28, wherein the one or more films comprise:
at least one of Si₃N₄, Al₂O₃, Ta₂O₅, TiO₂, ZrO₂, or HfO₂.

30. The metrology system of claim 28, wherein the inversion-symmetric substrate comprises:
silicon.

31. The metrology system of claim 28, wherein at least one of the one or more metrology measurements comprises:
at least one of a threshold voltage (Vₜ) or a value indicative of the threshold voltage (Vₜ).

32. The metrology system of claim 28, wherein the one or more processors are further configured to execute program instructions causing the one or more processors to:
control one or more process tools for fabricating the at least one of the high-k layer or the interfacial dipole engineering layer based on the one or more metrology measurements.

33. The metrology system of claim 24, wherein the one or more processors are further configured to execute program instructions causing the one or more processors to:
control one or more process tools for fabricating at least a portion of the sample based on the one or more metrology measurements.

34. The metrology system of claim 24, wherein the metrology data from the detector associated with the second harmonic of the illumination beam comprises:
temporally-resolved measurements of the SHG light in response to illuminating the sample with the illumination beam, wherein at least one of the one or more metrology measurements are generated based on the temporally-resolved measurements of the SHG light.

35. The metrology system of claim 34, wherein at least one of the one or more metrology measurements is based on at least one of a saturation intensity of the SHG light, a slope of the intensity of the SHG light, or an intensity of the SHG light at a selected time.

36. The metrology system of claim 34, wherein the temporally-resolved measurement is associated with intermittent illumination of the sample with the illumination beam.

37. The metrology system of claim 34, wherein at least one of the one or more metrology measurements is based on intensity of the SHG light associated with intermittent illumination of the sample with the illumination beam.

38. The metrology system of claim 24, wherein the metrology data from the detector associated with the second harmonic of the illumination beam comprises:
wavelength-resolved measurements of the SHG light in response to illuminating the sample with the illumination beam having two or more wavelengths, wherein at least one of the one or more metrology measurements are generated based on the wavelength-resolved measurements of the SHG light.

39. The metrology system of claim 38, wherein at least one of the one or more metrology measurements includes a depth-dependent measurement.

40. The metrology system of claim 24, wherein the metrology data from the detector associated with the second harmonic of the illumination beam comprises:
temporally-resolved measurements of the SHG light in response to illuminating the sample with at least one of an additional illumination beam or an electric field, wherein at least one of the one or more metrology measurements are generated based on the temporally-resolved measurements of the SHG light.

41. The metrology system of claim 40, wherein the temporally-resolved measurement is associated with intermittent illumination of the sample with at least one of the additional illumination beam or the electric field while the illumination beam is constant.

42. The metrology system of claim 40, wherein the temporally-resolved measurement is associated with intermittent illumination of the sample with the illumination beam and the at least one of the additional illumination beam or the electric field.

43. A metrology method, comprising:
directing an illumination beam at a sample, wherein the sample includes an inversion-symmetric substrate and one or more films disposed on the inversion-symmetric substrate;
capturing metrology data based on second harmonic generation (SHG) light from the sample associated with an interface between the inversion-symmetric substrate and the one or more films; and
generating one or more metrology measurements associated with the one or more films based on the metrology data.

44. The metrology method of claim 43, wherein generating one or more metrology measurements associated with the one or more films based on the SHG light associated with an interface between the inversion-symmetric substrate and the one or more films comprises:
generating metrology measurements of at least one of layer thickness, layer composition, presence of defects, charge/trap states, stress/strain, charge mobility, or surface/interface roughness associated with at least one of the one or more films.

45. The metrology method of claim 43, wherein the interface between the inversion-symmetric substrate and the one or more films is associated with a gate region of at least one of a field effect transistor (FET), a metal-oxide-semiconductor FET (MOSFET), a planar FET, a FinFET, GAA nanosheet FET, a fork-sheet FET, a complimentary GAA FET, a ferroelectric FET, or a 2D FET.

46. The metrology method of claim 45, wherein generating one or more metrology measurements associated with the one or more films based on the SHG light associated with an interface between the inversion-symmetric substrate and the one or more films comprises:
generating metrology measurements of a threshold voltage (Vₜ).

47. The metrology method of claim 45, wherein the one or more films comprise:
at least one of a high-k layer or an interfacial dipole engineering layer.

48. The metrology method of claim 45, further comprising:
controlling one or more process tools for fabricating the at least one of the high-k layer or the interfacial dipole engineering layer based on the one or more metrology measurements.

49. The metrology method of claim 43, further comprising:
controlling one or more process tools for fabricating at least a portion of the sample based on the one or more metrology measurements.

50. The metrology method of claim 43, wherein generating one or more metrology measurements associated with the one or more films based on the SHG light associated with the interface between the inversion-symmetric substrate and the one or more films comprises:
generating calibration metrology data based on the SHG light associated with known variations of the interface between the inversion-symmetric substrate and the one or more films; and
generating one or more metrology measurements for the sample associated with the one or more films based on the SHG light from the sample and the calibration metrology data.
